(19) United States
(12) Patent Application Publication
(10) Pub. No.: US 2025/0252784 A1
(43) Pub. Date: Aug. 7, 2025

(54) FAKE FINGERPRINT RECOGNITION DEVICE AND FAKE FINGERPRINT RECOGNITION METHOD

(71) Applicant: REALTEK SEMICONDUCTOR CORPORATION, Hsinchu (TW)

(72) Inventors: YU-CHI TSAI, Hsinchu (TW); Chih-Yuan Cheng, Hsinchu (TW); Yi-Hsuan Huang, Hsinchu (TW); Wen-Tsung Huang, Hsinchu (TW)

(21) Appl. No.: 19/036,274

(22) Filed: Jan. 24, 2025

(30) Foreign Application Priority Data
Feb. 1, 2024 (TW) 113104054

(51) Int. Cl. G06V 40/40; G06V 40/12

(52) U.S. Cl. CPC G06V 40/45; G06V 40/1365; G06V 40/1347

(57) ABSTRACT

A fake fingerprint recognition device includes a memory and a processor. The memory is configured to store at least one command. The processor is configured to read the at least one command to execute following steps: receiving an input fingerprint image; calculating a fingerprint index according to the input fingerprint image and a registered fingerprint image in a fingerprint database, wherein the input fingerprint image corresponds to the registered fingerprint image, and the registered fingerprint image is stored in the fingerprint database in advance; determining whether the fingerprint index is larger than a predetermined index threshold; and if the fingerprint index is larger than the predetermined index threshold, determining that the input fingerprint image is a fake fingerprint image.

### BACKGROUND OF THE INVENTION

### 1. Field of the Invention

The present disclosure relates to a fake fingerprint recognition device and a fake fingerprint recognition method, especially to a fake fingerprint recognition device and a fake fingerprint recognition method that stores registered fingerprint images in advance for comparing with input fingerprint images.

### 2. Description of Related Art

With the advancement of technology, fingerprint recognition has become one of the most commonly used unlocking methods for electronic devices. However, lawbreakers can duplicate fingerprints of consumers to create fake fingerprints for stealing information or property of consumers.

To prevent information or property of consumers from stealing, the industry has proposed various techniques for recognizing fake fingerprints. For example, various techniques are a live fingerprint recognition for measuring finger blood flow, a fake fingerprint determining technology using image indicators such as spectrum and reflectance of fingerprint images, or a fake fingerprint identifying technology adopting human indicators such as sweat pore density in fingerprint images.

However, various techniques for recognizing fake fingerprints mentioned above all have their disadvantages. For example, the above-mentioned live fingerprint recognition needs additional optical sensors, and the costs is therefore high. Furthermore, if determinations in the above-mentioned technologies are based on features such as spectrum, reflectance, sweat pore density, etc., there are still risks that lawbreakers can duplicate fingerprints of consumers to create fake fingerprints based on these features.

### SUMMARY OF THE INVENTION

In some aspects, an object of the present disclosure is to, but not limited to, provides a fake fingerprint recognition device and a fake fingerprint recognition method that makes an improvement to the prior art.

An embodiment of a fake fingerprint recognition device of the present disclosure includes a memory and a processor. The memory is configured to store at least one command. The processor is configured to read the at least one command to execute following steps: receiving an input fingerprint image; calculating a fingerprint index according to the input fingerprint image and a registered fingerprint image in a fingerprint database, wherein the input fingerprint image corresponds to the registered fingerprint image, and the registered fingerprint image is stored in the fingerprint database in advance; determining whether the fingerprint index is larger than a predetermined index threshold; and if the fingerprint index is larger than the predetermined index threshold, determining that the input fingerprint image is a fake fingerprint image.

An embodiment of a fake fingerprint recognition method of the present disclosure which is executed by a processor reading at least one command includes following steps: receiving an input fingerprint image; calculating a fingerprint index according to the input fingerprint image and a registered fingerprint image of a fingerprint database, wherein the input fingerprint image corresponds to the registered fingerprint image, and the registered fingerprint image is stored in the fingerprint database in advance; determining whether the fingerprint index is larger than a predetermined index threshold; and if the fingerprint index is larger than the predetermined index threshold, determining that the input fingerprint image is a fake fingerprint image.

Technical features of some embodiments of the present disclosure make an improvement to the prior art. The fake fingerprint recognition device and the fake fingerprint recognition method of the present disclosure identify fake fingerprints by comparing a registered fingerprint image stored in advance with an input fingerprint image. Since the registered fingerprint image is a fingerprint image of a user which is stored in advance, if the input fingerprint image of the same user is utilized to be compared with the registered fingerprint image, fake fingerprints can be recognized effectively and accurately.

Furthermore, since the present disclosure does not need additional optical sensors for live fingerprint recognition, the present disclosure can address the issue of high costs associated with live fingerprint recognition. In addition, compared to the prior art that analyze big data to determine fake fingerprints based on features such as spectrum, reflectance, sweat pore density, etc., the present disclosure utilizes fingerprint images of the same user to execute the comparison, such that determinations of fake fingerprints are accurate and the problems of duplicating fingerprints of consumers to create fake fingerprints by lawbreakers can be avoided.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a fake fingerprint recognition device and a fingerprint database of the present disclosure.

FIG. 2 shows an embodiment of a flow diagram of a fake fingerprint recognition method of the present disclosure.

FIG. 3 shows an embodiment of a real fingerprint image and a fake fingerprint image of the present disclosure.

FIG. 4 shows an embodiment of a real fingerprint image of the present disclosure.

FIG. 5 shows an embodiment of a real fingerprint image of the present disclosure.

FIG. 6 shows an embodiment of a registered fingerprint image, an input fingerprint image, and an overlapped image of the present disclosure.

FIG. 7 shows an embodiment of a registered fingerprint image, an input fingerprint image, and an overlapped image of the present disclosure.

### DETAILED DESCRIPTION OF THE PREFERRED EMBODIMENTS

There are still problems need to be improved in the prior art, for example, the live fingerprint recognition in the prior needs additional optical sensors resulting in high costs, and if determinations are made based on features such as spectrum, reflectance, sweat pore density, etc., there are still risks that lawbreakers can duplicate fingerprints of consumers to create fake fingerprints based on these features. The present disclosure provides a fake fingerprint recognition device and a fake fingerprint recognition method, which will be explained in detail as below.

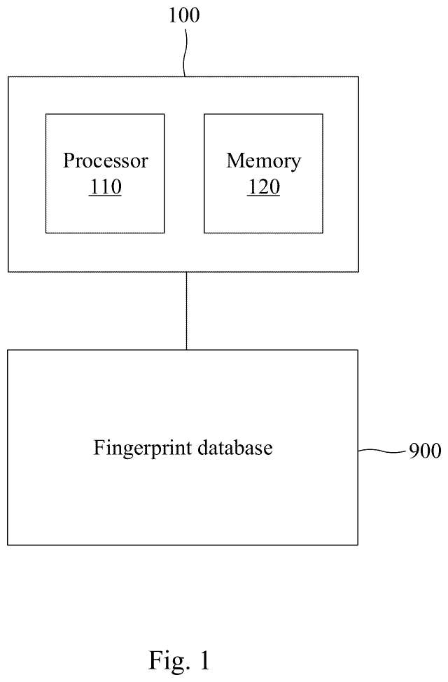

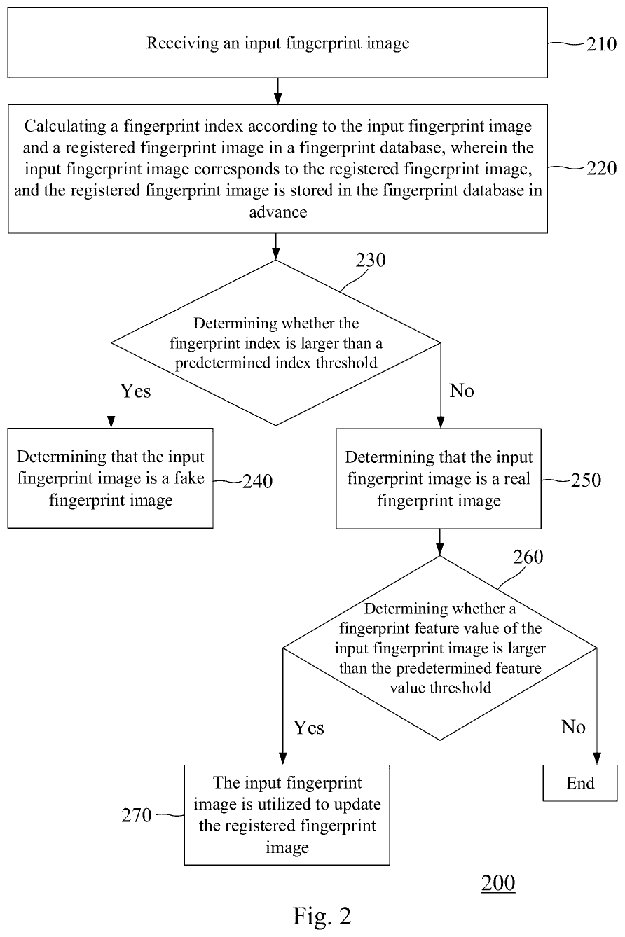

FIG. 1 shows an embodiment of a fake fingerprint recognition device 100 and a fingerprint database 900 of the present disclosure. As shown in the figure, the fake fingerprint recognition device 100 includes a processor 110 and a memory 120. The memory 120 is configured to store at least one command. The processor 110 is configured to read at least one command to execute a fake fingerprint recognition. For facilitating the understanding of operations of the fake fingerprint recognition device 100, reference is now made to FIG. 2. FIG. 2 shows an embodiment of a flow diagram of a fake fingerprint recognition method 200 of the present disclosure.

First of all, in some embodiments, fingerprint images can be captured by sensors such as capacitive sensors, optical sensors, ultrasonic sensors, and so on. The captured fingerprint images are typically grayscale (two dimensional, 2D) images, which can represent the ridges and valleys of the fingerprints faithfully. Additionally, before executing the fake fingerprint recognition method 200, the present disclosure may execute preprocessing on the fingerprint images. The preprocessing may include noise reduction, smoothing, edge enhancement, and other treatments on the fingerprint images. The preprocessing can be executed by mean filters, sharpening filters, and so on. Normalization techniques such as Histogram Equalization can also be employed for processing.

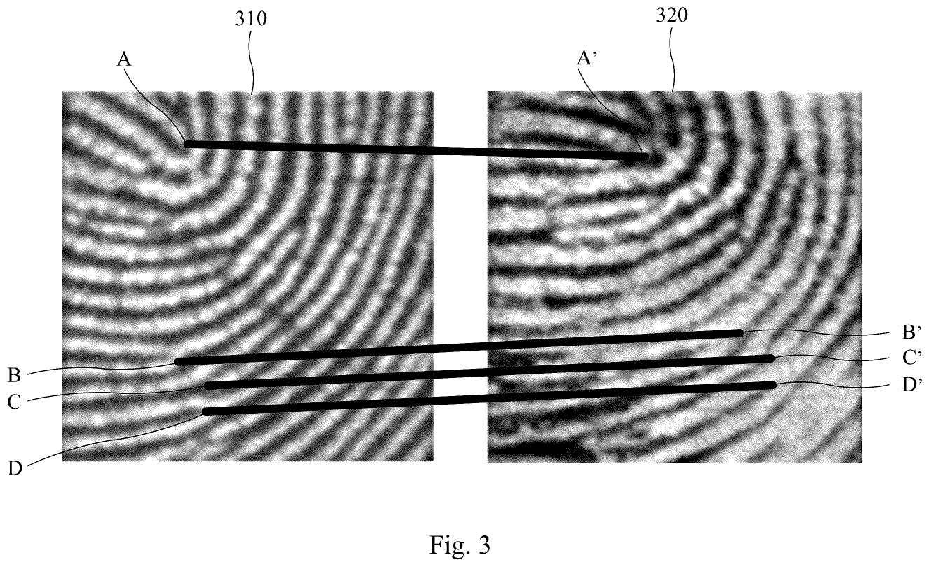

Referring to FIG. 1 and FIG. 2, in step 210, receiving an input fingerprint image. For example, referring to FIG. 3, FIG. 3 shows an embodiment of a real input fingerprint image 310 and a fake fingerprint image 320 of the present disclosure. As shown in FIG. 3, the real input fingerprint image 310 and the fake fingerprint image 320 are extremely similar. For example, the relative positions, branching conditions, shapes, etc., of feature points A-D of the real input fingerprint image 310 and that of the feature points A′-D′ in the fake fingerprint image 320 are extremely similar. If a conventional fingerprint recognition method is employed, there is a risk of determining that the real input fingerprint image 310 and the fake fingerprint image 320 are the same fingerprint. However, in reality, the fingerprint image 320 on the right side of FIG. 3 is merely a fake fingerprint image duplicated by lawbreakers. Reference is now made to step 210, the present disclosure can receive the input fingerprint image 310 on the left side for subsequent calculations.

In step 220, calculating a fingerprint index according to the input fingerprint image and a registered fingerprint image stored in a fingerprint database, wherein the input fingerprint image corresponds to the registered fingerprint image, and the registered fingerprint image is stored in the fingerprint database in advance. For example, referring to FIG. 1 and FIG. 3, the present disclosure can calculate a fingerprint index according to the input fingerprint image 310 and the registered fingerprint image stored in the fingerprint database 900. The input fingerprint image 310 is related to the registered fingerprint image, for example the input fingerprint image 310 and the registered fingerprint image correspond to the same fingerprint, and the registered fingerprint image is stored in the fingerprint database 900 in advance.

In some embodiments, the registered fingerprint image is obtained from a user in advance and stored in the fingerprint database 900 before the present disclosure executes the fake fingerprint recognition method 200. Furthermore, the input fingerprint image 310 refers to the fingerprint image received in real-time during the operation of the present disclosure. The input fingerprint image 310 and the registered fingerprint image are utilized for real-time calculations (such as comparation operations) to obtain a fingerprint index which facilitates subsequent determinations regarding whether the input fingerprint image 310 is a fake fingerprint image.

In step 230, determining whether the fingerprint index is larger than a predetermined index threshold. In step 240, if the fingerprint index is larger than the predetermined index threshold, determining that the input fingerprint image is a fake fingerprint image. For example, for determining whether the input fingerprint image 310 is a fake fingerprint image, the present disclosure can set a determination index, for example, an image contrast index can be set as the determination index. The fingerprint index in the above-mentioned steps 220-240 can be the image contrast index, and the predetermined index threshold can be a predetermined contrast index threshold. The present disclosure can calculate the image contrast index according to the input fingerprint image 310 and the registered fingerprint image, and determine whether the image contrast index is larger than the predetermined contrast index threshold. If the image contrast index is larger than the predetermined contrast index threshold, it is determined that the input fingerprint image 310 is the fake fingerprint image, and a fake fingerprint warning signal is outputted.

In some embodiments, the formula of the image contrast index is as follows:

$${C}_{i} = \frac{2 {α}_{x} {α}_{y} + k}{{α}_{x}^{2} + {α}_{y}^{2} + k} \qquad formula 1$$

As shown in formula 1, Cᵢ is the image contrast index, αₓ and α_{y} are the standard deviations of the input fingerprint image 310 and the registered fingerprint image respectively, and k is a constant. If the value of the image contrast index Cᵢ is larger, the probability that the input fingerprint image 310 is a fake fingerprint is higher. The predetermined contrast index threshold in the present disclosure is set at 0.8, but the predetermined contrast index threshold is not limited to 0.8. After calculating according to formula 1, if the image contrast index Cᵢ is larger than the predetermined contrast index threshold of 0.8, the determination is made that the input fingerprint image 310 is a fake fingerprint image.

In some embodiments, if it is determined that the input fingerprint image 310 is a fake fingerprint image, the present disclosure can generate a fake fingerprint warning signal (e.g., notification or email) to alert users that lawbreakers want to log in utilizing the fake fingerprint. For example, a warning notification or a warning email about the fake fingerprint can be set by users to send to computers, mobile phones, or other electronic devices of users, such that users can take appropriate actions (e.g., preventive measures). In alternative embodiments, if it is determined that the input fingerprint image 310 is a fake fingerprint image, the present disclosure can also deny lawbreaker to log in utilizing the fake fingerprint, such that information or property of users can be prevented from stealing.

In step 250, if the fingerprint index is not larger than the predetermined index threshold, determining that the input fingerprint image is a real fingerprint image. For example, after the determination of step 230, if the fingerprint index (e.g., the image contrast index) is not larger than the predetermined index threshold (e.g., the predetermined contrast index threshold), the present disclosure determines that the input fingerprint image 310 is a real fingerprint image.

In step 260, if the fingerprint index is not larger than the predetermined index threshold, determining whether a fingerprint feature value of the input fingerprint image is larger than a predetermined feature value threshold. In step 270, if the fingerprint feature value of the input fingerprint image is larger than the predetermined feature value threshold, the input fingerprint image is utilized to update the registered fingerprint image in the fingerprint database. For example, for maintaining or even improving the accuracy of the fingerprint recognition of the present disclosure, after the determination of step 230, if it is determined that the input fingerprint image 310 is a real fingerprint image, the present disclosure will further determine whether to update the registered fingerprint image stored in the fingerprint database 900 with the latest input fingerprint image 310. The present disclosure will set a predetermined feature value threshold, and determine whether a fingerprint feature value of the input fingerprint image 310 is larger than the predetermined feature value threshold. If the fingerprint feature value of the input fingerprint image 310 is larger than the predetermined feature value threshold, the present disclosure will update the fingerprint database 900 with the latest input fingerprint image 310, for example, the registered fingerprint image stored in the fingerprint database 900 will be replaced by the input fingerprint image 310, or the input fingerprint image 310 will be added to be a new registered fingerprint image.

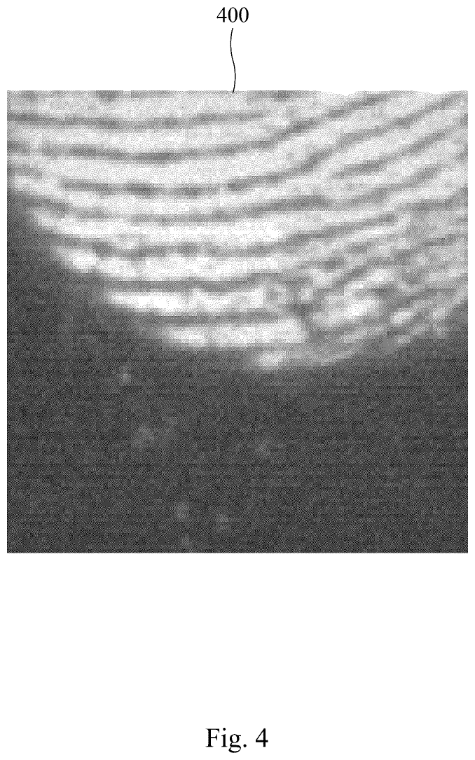

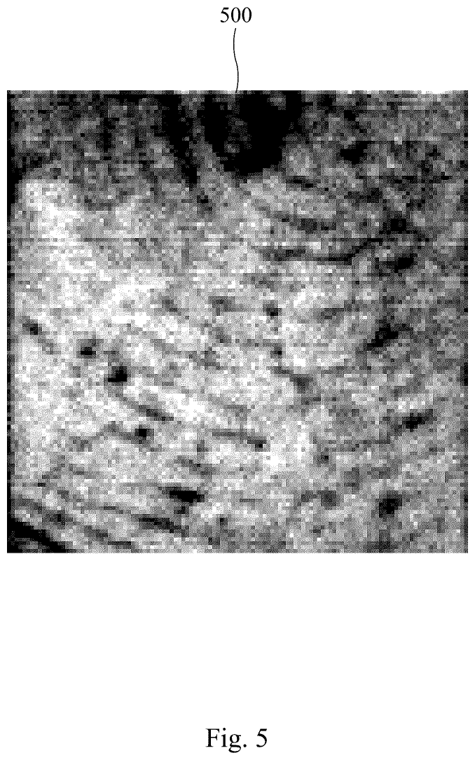

In some embodiments, the fingerprint feature value of the input fingerprint image 310 in step 260 can be a fingerprint effective area ratio or a fingerprint definition. FIG. 4 and FIG. 5 show embodiments of real input fingerprint images 400, 500 of the present disclosure. As shown in FIG. 4, the fingerprint effective area ratio of the input fingerprint image 400 is low (lower than the predetermined area ratio threshold). Therefore, even if the input fingerprint image 400 is determined to be a real fingerprint image, the present disclosure will not utilize the input fingerprint image 400 to update the registered fingerprint image stored in the fingerprint database. On the contrary, if the fingerprint effective area ratio of the input fingerprint image 400 is larger than the predetermined area ratio threshold, the present disclosure will utilize the input fingerprint image 400 to update the registered fingerprint image stored in the fingerprint database 900. The predetermined area ratio threshold provided by the present disclosure can be 50%, but the predetermined area ratio threshold is not limited to 50%.

As shown in FIG. 5, the fingerprint definition of the input fingerprint image 500 is low (lower than a definition threshold). Therefore, even if the input fingerprint image 500 is determined to be a real fingerprint image, the present disclosure will not utilize the input fingerprint image 500 to update the registered fingerprint image stored in the fingerprint database 900. On the contrary, if the fingerprint definition of the input fingerprint image 500 is larger than the predetermined definition threshold, the present disclosure will utilize the input fingerprint image 500 to update the registered fingerprint image stored in the fingerprint database 900. The predetermined definition threshold provided by the present disclosure can be 0.8, but the predetermined definition threshold is not limited to 0.8.

In some embodiments, the processor 110 of the present disclosure is further configured to read the at least one command to execute following steps: obtaining at least one input fingerprint feature value of the input fingerprint image; determining whether the input fingerprint image matches the registered fingerprint image according to the at least one input fingerprint feature value; and if the input fingerprint image matches the registered fingerprint image, calculating the fingerprint index according to the input fingerprint image and the registered fingerprint image. For example, before calculating the fingerprint index in step 220, the present disclosure will determine whether the input fingerprint image 310 matches the registered fingerprint image in the fingerprint database 900. The determination includes obtaining the input fingerprint feature value of the input fingerprint image 310 firstly, and based on the input fingerprint feature value, determining whether the input fingerprint image 310 matches any of registered fingerprint images in the fingerprint database 900. If it is determined that the input fingerprint image 310 matches any of registered fingerprint images in the fingerprint database 900, the present disclosure calculates the fingerprint index according to the input fingerprint image 310 and the registered fingerprint image, and determines whether the input fingerprint image 310 is a fake fingerprint image.

In some embodiments, the input fingerprint feature value of the input fingerprint image 310 may include fingerprint contrast, overall brightness, structural characteristics, features in the frequency domain, feature points, pattern characteristics, pattern types, and so on. The feature points may include positional information, importance, representative region scope, directionality, and relative relationships with other feature points. The pattern characteristics may include gradient histograms, structural characteristics, and so on. The pattern types may include bifurcation points, line segment starting points, patterns with spiral direction among entire region, and so on.

In some embodiments, the processor 110 of the present disclosure is further configured to read the at least one command to execute following steps: obtaining at least one input fingerprint feature of the input fingerprint image; determining whether the at least one input fingerprint feature of the input fingerprint image matches a registered fingerprint feature of the registered fingerprint image; and if the at least one input fingerprint feature of the input fingerprint image matches the registered fingerprint feature of the registered fingerprint image, calculating the fingerprint index according to the input fingerprint image and the registered fingerprint image. For example, before calculating the fingerprint index in step 220, the present disclosure will determine whether the input fingerprint image 310 matches the registered fingerprint image. The determination includes obtaining the input fingerprint feature of the input fingerprint image 310 and determining whether the input fingerprint feature of the input fingerprint image 310 matches the registered fingerprint feature of the registered fingerprint image. If it is determined that the input fingerprint feature of the input fingerprint image 310 matches the registered fingerprint feature of the registered fingerprint image, the present disclosure calculates the fingerprint index according to the input fingerprint image 310 and the registered fingerprint image. In some embodiments, the present disclosure can compare the input fingerprint feature of the input fingerprint image 310 with the registered fingerprint features of multiple registered fingerprint images in the fingerprint database 900 one by one to determine whether the input fingerprint image 310 matches the registered fingerprint image in the fingerprint database 900.

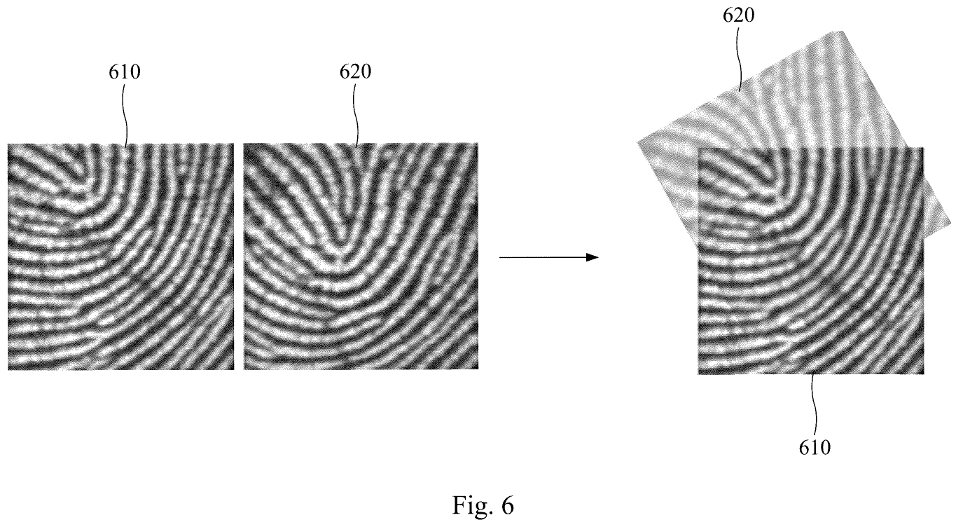

In some embodiments, the processor 110 of the present disclosure is further configured to read the at least one command to execute following steps: determining whether the input fingerprint image after rotation and translation overlaps with the registered fingerprint image; and if the input fingerprint image after rotation and translation overlaps with the registered fingerprint image, calculating the fingerprint index according to the input fingerprint image and the registered fingerprint image. For example, referring to FIG. 6, before calculating the fingerprint index in step 220, the present disclosure will determine whether the input fingerprint image 620 on the left side of FIG. 6 overlaps with the registered fingerprint image 610. The determination includes rotating and translating the input fingerprint image 620 and determining whether the input fingerprint image 620 after rotation and translation overlaps with the registered fingerprint image 610. As shown on the right side of FIG. 6, the input fingerprint image 620 indeed overlaps with the registered fingerprint image 610. Subsequently, the present disclosure calculates the fingerprint index according to the input fingerprint image 620 and the registered fingerprint image 610 to determine whether the input fingerprint image 620 is a fake fingerprint image.

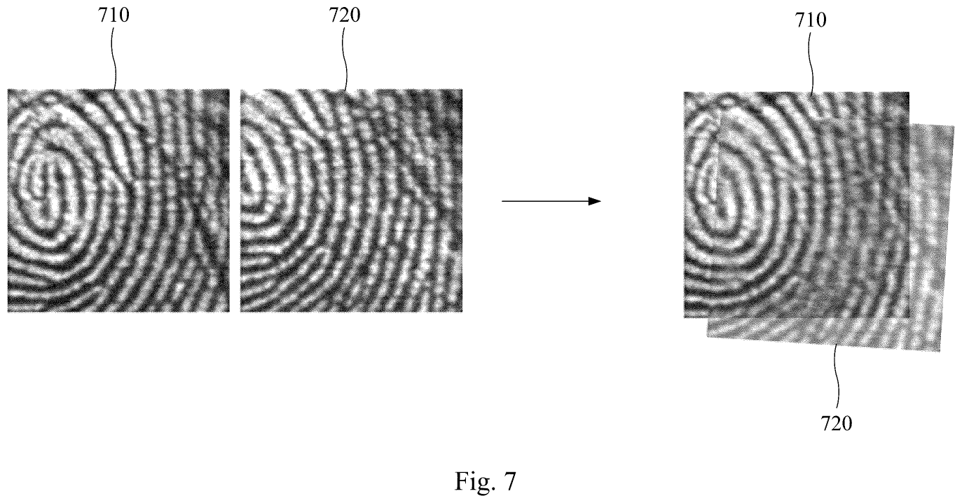

Besides, referring to FIG. 7, before calculating the fingerprint index in step 220, the present disclosure will determine the input fingerprint image 720 on the left side of FIG. 7 overlaps with the registered fingerprint image 710. The determination includes rotating and translating the input fingerprint image 720 and determining whether the input fingerprint image 720 after rotation and translation overlaps with the registered fingerprint image 710. As shown on the right side of FIG. 7, the input fingerprint image 720 indeed overlaps with the registered fingerprint image 710. Subsequently, the present disclosure calculates the fingerprint index according to the input fingerprint image 720 and the registered fingerprint image 710 to determine whether the input fingerprint image 720 is a fake fingerprint image.

It is noted that the present disclosure is not limited to the embodiments as shown in FIG. 1 to FIG. 7, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

In view of the above, the fake fingerprint recognition device 100 and the fake fingerprint recognition method 200 of the present disclosure identify fake fingerprints by comparing a registered fingerprint image stored in advance with an input fingerprint image. Since the registered fingerprint image is a fingerprint image of a user which is stored in advance, if the input fingerprint image of the same user is utilized to be compared with the registered fingerprint image, fake fingerprints can be recognized effectively and accurately.

Furthermore, since the present disclosure does not need additional optical sensors for live fingerprint recognition, the present disclosure can address the issue of high costs associated with live fingerprint recognition. In addition, compared to the prior art that analyze big data to determine fake fingerprints based on features such as spectrum, reflectance, sweat pore density, etc., the present disclosure utilizes fingerprint images of the same user to execute the comparison, such that determinations of fake fingerprints are accurate and the problems of duplicating fingerprints of consumers to create fake fingerprints by lawbreakers can be avoided.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A fake fingerprint recognition device, comprising:
a memory, configured to store at least one command; and
a processor, configured to read the at least one command to execute following steps:
receiving an input fingerprint image;
calculating a fingerprint index according to the input fingerprint image and a registered fingerprint image in a fingerprint database, wherein the input fingerprint image corresponds to the registered fingerprint image, and the registered fingerprint image is stored in the fingerprint database in advance;
determining whether the fingerprint index is larger than a predetermined index threshold; and
if the fingerprint index is larger than the predetermined index threshold, determining that the input fingerprint image is a fake fingerprint image.

2. The fake fingerprint recognition device of claim 1, wherein the fingerprint index comprises an image contrast index, and the predetermined index threshold comprises a predetermined contrast index threshold, wherein the processor is further configured to read the at least one command to execute following steps:
calculating the image contrast index according to the input fingerprint image and the registered fingerprint image;
determining whether the image contrast index is larger than the predetermined contrast index threshold; and
if the image contrast index is larger than the predetermined contrast index threshold, determining that the input fingerprint image is the fake fingerprint image, and outputting a fake fingerprint warning signal.

3. The fake fingerprint recognition device of claim 1, wherein the input fingerprint image and the registered fingerprint image correspond to a same fingerprint.

4. The fake fingerprint recognition device of claim 1, wherein the registered fingerprint image is obtained in advance and stored in the fingerprint database in advance, the input fingerprint image is received in real-time, and the input fingerprint image and the registered fingerprint image are utilized to execute a real-time calculation to obtain the fingerprint index.

5. The fake fingerprint recognition device of claim 1, wherein the processor is further configured to read the at least one command to execute following steps:
if the fingerprint index is not larger than the predetermined index threshold, determining whether a fingerprint feature value of the input fingerprint image is larger than a predetermined feature value threshold; and
if the fingerprint feature value of the input fingerprint image is larger than the predetermined feature value threshold, utilizing the input fingerprint image to update the registered fingerprint image.

6. The fake fingerprint recognition device of claim 1, wherein the processor is further configured to read the at least one command to execute following steps:
if the fingerprint index is not larger than the predetermined index threshold, determining whether a fingerprint effective area ratio of the input fingerprint image is larger than a predetermined area ratio threshold, or determining whether a fingerprint definition of the input fingerprint image is larger than a predetermined definition threshold; and
if the fingerprint effective area ratio of the input fingerprint image is larger than the predetermined area ratio threshold or the fingerprint definition of the input fingerprint image is larger than the predetermined definition threshold, utilizing the input fingerprint image to update the registered fingerprint image.

7. The fake fingerprint recognition device of claim 1, wherein the processor is further configured to read the at least one command to execute following steps:
obtaining at least one input fingerprint feature value of the input fingerprint image;
determining whether the input fingerprint image matches the registered fingerprint image according to the at least one input fingerprint feature value; and
if the input fingerprint image matches the registered fingerprint image, calculating the fingerprint index according to the input fingerprint image and the registered fingerprint image.

8. The fake fingerprint recognition device of claim 1, wherein the processor is further configured to read the at least one command to execute following steps:
obtaining at least one input fingerprint feature of the input fingerprint image;
determining whether the at least one input fingerprint feature of the input fingerprint image matches a registered fingerprint feature of the registered fingerprint image; and
if the at least one input fingerprint feature of the input fingerprint image matches the registered fingerprint feature of the registered fingerprint image, calculating the fingerprint index according to the input fingerprint image and the registered fingerprint image.

9. The fake fingerprint recognition device of claim 1, wherein the processor is further configured to read the at least one command to execute following steps:
determining whether the input fingerprint image after rotation and translation overlaps with the registered fingerprint image; and
if the input fingerprint image after the rotation and translation overlaps with the registered fingerprint image, calculating the fingerprint index according to the input fingerprint image and the registered fingerprint image.

10. The fake fingerprint recognition device of claim 1, wherein the processor is further configured to read the at least one command to execute following steps:
if the fingerprint index in not larger than the predetermined index threshold, determining that the input fingerprint image is a real fingerprint image.

11. A fake fingerprint recognition method, which is executed by a processor reading at least one command, comprising:
receiving an input fingerprint image;
calculating a fingerprint index according to the input fingerprint image and a registered fingerprint image in a fingerprint database, wherein the input fingerprint image corresponds to the registered fingerprint image, and the registered fingerprint image is stored in the fingerprint database in advance;
determining whether the fingerprint index is larger than a predetermined index threshold; and
if the fingerprint index is larger than the predetermined index threshold, determining that the input fingerprint image is a fake fingerprint image.

12. The fake fingerprint recognition method of claim 11, wherein the fingerprint index comprises an image contrast index, and the predetermined index threshold comprises a predetermined contrast index threshold;
wherein calculating the fingerprint index according to the input fingerprint image and the registered fingerprint image in the fingerprint database comprises:
calculating the image contrast index according to the input fingerprint image and the registered fingerprint image;
wherein determining whether the fingerprint index is larger than the predetermined index threshold comprises:
determining whether the image contrast index is larger than the predetermined contrast index threshold; and
wherein if the fingerprint index is larger than the predetermined index threshold, determining that the input fingerprint image is the fake fingerprint image comprises:
if the image contrast index is larger than the predetermined contrast index threshold, determining that the input fingerprint image is the fake fingerprint image, and outputting a fake fingerprint warning signal.

13. The fake fingerprint recognition method of claim 11, wherein the input fingerprint image and the registered fingerprint image correspond to a same fingerprint.

14. The fake fingerprint recognition method of claim 11, wherein the registered fingerprint image is obtained in advance and stored in the fingerprint database in advance, the input fingerprint image is received in real-time, and the input fingerprint image and the registered fingerprint image are utilized to execute a real-time calculation to obtain the fingerprint index.

15. The fake fingerprint recognition method of claim 11, further comprising:
if the fingerprint index is not larger than the predetermined index threshold, determining whether a fingerprint feature value of the input fingerprint image is larger than a predetermined feature value threshold; and
if the fingerprint feature value of the input fingerprint image is larger than the predetermined feature value threshold, utilizing the input fingerprint image to update the registered fingerprint image.

16. The fake fingerprint recognition method of claim 11, further comprising:
if the fingerprint index is not larger than the predetermined index threshold, determining whether a fingerprint effective area ratio of the input fingerprint image is larger than a predetermined area ratio threshold, or determining whether a fingerprint definition of the input fingerprint image is larger than a predetermined definition threshold; and
if the fingerprint effective area ratio of the input fingerprint image is larger than the predetermined area ratio threshold or the fingerprint definition of the input fingerprint image is larger than the predetermined definition threshold, utilizing the input fingerprint image to update the registered fingerprint image.

17. The fake fingerprint recognition method of claim 11, further comprising:
obtaining at least one input fingerprint feature value of the input fingerprint image;
determining whether the input fingerprint image matches the registered fingerprint image according to the at least one input fingerprint feature value; and
if the input fingerprint image matches the registered fingerprint image, calculating the fingerprint index according to the input fingerprint image and the registered fingerprint image.

18. The fake fingerprint recognition method of claim 11, further comprising:
obtaining at least one input fingerprint feature of the input fingerprint image;
determining whether the at least one input fingerprint feature of the input fingerprint image matches a registered fingerprint feature of the registered fingerprint image; and
if the at least one input fingerprint feature of the input fingerprint image matches the registered fingerprint feature of the registered fingerprint image, calculating the fingerprint index according to the input fingerprint image and the registered fingerprint image.

19. The fake fingerprint recognition method of claim 11, further comprising:
determining whether the input fingerprint image after rotation and translation overlaps with the registered fingerprint image; and
if the input fingerprint image after the rotation and translation overlaps with the registered fingerprint image, calculating the fingerprint index according to the input fingerprint image and the registered fingerprint image.

20. The fake fingerprint recognition method of claim 11, further comprising:
if the fingerprint index in not larger than the predetermined index threshold, determining that the input fingerprint image is a real fingerprint image.
